(19) United States
(12) Patent Application Publication
(10) Pub. No.: US 2023/0198420 A1
(43) Pub. Date: Jun. 22, 2023

(54) Phase Regulated AC to DC Power Supplies and Related Methods

(71) Applicant: Daniel Joseph Gregory, Clayton, NC (US)

(72) Inventor: Daniel Joseph Gregory, Clayton, NC (US)

(21) Appl. No.: 18/112,718

(22) Filed: Feb. 22, 2023

Related U.S. Application Data
(60) Provisional application No. 63/315,734, filed on Mar. 2, 2022.

(51) Int. Cl. H02M 7/162; H02M 1/08; H02M 1/14; H02M 1/00

(52) U.S. Cl. CPC H02M 7/1626; H02M 1/082; H02M 1/143; H02M 1/0009

(57) ABSTRACT

In described examples, a Phase Regulated Power Supply includes a low output DC logic power supply, a voltage divider to sample the input AC waveform, one or more comparators, digital logic, and a switching transistor. It can include a Full Wave Rectifier and one or more capacitors, inductors and opto-isolators. In the most basic form, Alternating Current (AC) power is switched directly to a load when the AC instantaneous voltage is between a low and high set-point. Voltage is regulated by controlling the high set-point. Current through the load is regulated by briefly extinguishing the AC input from the load when the load current exceeds a set parameter. Voltage output to the load is adjustable from zero volts to the AC peak voltage. Current through the load is adjustable from zero amps to the AC circuit breaker limit.

### TECHNICAL FIELD

The presently disclosed subject matter relates generally to a novel approach for extracting energy from an input AC power source through phase timing and delivering this energy as DC at a desired voltage directly to a load while regulating voltage and current. Such a system replaces many current AC to DC power supplies that use transformers, complex switching methods and voltage regulators.

### BACKGROUND

Most electronic equipment in the world makes use of circuitry that converts electrical mains Alternating Current (AC) electricity into Direct Current (DC). This circuitry, often called a “Power Supply”:
a. Reduces the AC mains voltage to a smaller output voltage through use of a step-down transformer.
b. Converts AC electrical mains energy to DC through rectification.
c. Smooths output ripple and removes noise to create a stable DC voltage.
d. Regulates the output voltage to withstand varying loads through either a simple voltage regulator or with a complex system of switching circuitry.
e. Regulates current through the load.

Existing power supplies typically output a fixed, non-adjustable voltage and are designed for specific load characteristics. Exceeding the design, load parameters can damage the power supply.

Existing power supplies are bulky and inefficient, consuming a considerable amount of input energy, producing undesirable heat in exchange that in many cases requires expending more energy to remove.

FIG. 1 illustrates a simple AC to DC power supply in typical use today. AC energy 100 is introduced to the primary windings 102 of a power transformer that reduces the voltage on the secondary 103 (step-down transformer). The transformer primary 102 is typically connected to the electrical hot and neutral premise wires. Note. the secondary 103 winding typically becomes isolated from the primary 102 and so a “DC common” or “DC ground” 104 will need to be established in the circuit downstream of the secondary winding 103. In FIG. 1, this “DC common” 104 is established on the negative pin of the Full Wave Rectifier (FWR) 105.

Such a power supply outputs a positive DC voltage 108 relative to DC common 104. A similar power supply producing a negative output voltage would make the positive terminals of the FWR 105 “DC Common”. The input and output waveform of the transformer are identical in behavior as both are comprised of sinusoidal cycles that include voltages from zero to positive peak then from zero to negative peak. The main difference is the lower secondary peak-to-peak voltage. FIG. 1 illustrates a typical power supply that reduces the AC input voltage 100 from 120VAC (RMS) to an output 108 of 12VDC.

A Full Wave Rectifier (FWR) 108 converts the AC mains energy to sinusoidal DC by flipping the negative AC input peaks to be above the zero-volt line using a trick of the one-way behavior of diodes that make up the FWR. The FWR typically establishes “DC common” aka “DC ground” 104.

Energy from 108 is delivered to a capacitor 106 that smooths out most of the sinusoidal component of the waveform making the resulting waveform mostly ripple-free. Capacitor 106 also stores energy as a sort of “energy pool” to be later used by the voltage regulator 107 to deliver a load stable voltage to the output 108.

Regulator 107 draws energy from the “energy pool” stored in capacitor 106 as needed to deliver a specific voltage to the output 108. To function, the “storage pool” voltage must be greater than the desired output voltage. Voltage regulators are rated by the fixed output voltage they produce and the amount of power they can deliver to a load. The voltage regulator 107 consumes “storage pool” energy as needed to output a lower “regulated” voltage. Since the “storage pool” voltage is greater than the desired output voltage, 107 disposes of the excess energy to DC common 104. This behavior mimics a variable voltage divider 101. As can be seen, such a device connected between the storage pool (a) and ground (b) will always waste energy but the regulator 107 is necessary here to maintain a predictable output voltage 108 under varying load. The more this load is expected to vary, the larger will be the “energy pool” voltage compared to the regulated output voltage. In many circuits of this type, the waste is considerable.

The power supply illustrated in FIG. 1 makes no attempt to regulate output current. Typically, short-circuiting the load powered by such a supply, results in damage to the power supply and often the load itself Regulating current is typically done by controlling the output voltage to the load. Voltage-based power supplies typically deliver a constant voltage to the load until an upper current limit is reached. Circuitry within the power supply then reduces output voltage to maintain the output current below some design threshold. Further “demand” from the load will ultimately cause the properly designed power supply to disconnect from the load before damage occurs to the power supply, the load or both.

Almost all AC to DC power supplies make use of a bulky transformer to step up or down the input voltage. The larger the output power requirements, the bulkier the transformer. This transformer often consumes so much space that it is impractical to include it in the device it powers (e.g., cell phones and laptop computers). The workaround for this is to locate the power supply (with transformer) outside of the device it powers, In other cases, the transformer is included in the device but requires the device to have a large enclosure to host it. Transformers are bulky, heavy, expensive, noisy, hot, and radiate magnetic flux that can interfere with normal circuit function.

Efficiency improvements to the typical power supply, such as Switch Mode Power Supplies (SMPS) exist that mitigate the inefficiency of the voltage regulator and in many cases controls current flow, but these designs still use transformers and additionally produce high frequency switching noise that without complex filtering and metallic gaussian cages, interferes with normal circuit function. Such supplies are complex and often-times expensive.

Power supplies are designed for limited purpose. For example, a 20 mW power supply will not meet the demands of a 50 W load. There are a large variety of input and output voltages that power supplies must be designed for. One cannot substitute a 12v power supply for a 3v power supply or vice-versa. Load dynamics impact the design as does space and weight considerations. Ultimately, there exists today as many different types of power supplies as there are devices that use them.

The objectives for the novel approach presented here are as follows:
1. Eliminate the transformer.
2. Regulate voltage and current without wasting energy.
3. Create a scalable design that can be adopted to any input or output voltage and any output power requirement.
4. Create a design compact enough that most of the circuitry can be placed into an integrated circuit.
5. Make the design simple and inexpensive.

### BRIEF DESCRIPTION OF THE DRAWINGS

FIG. 1 illustrates a typical AC to DC power supply presently in use.

FIG. 2 illustrates details of a sinusoidal AC waveform and its phases.

FIG. 3 illustrates the relationship between phase and instantaneous voltage for AC mains power typical in the USA and for a 1:16 sample.

FIG. 4 illustrates a full AC cycle when converted to alternating DC by a Full Wave Rectifier and is used to demonstrate the relationship between phase and instantaneous voltage.

FIG. 5 illustrates a basic phase regulated circuit.

### DETAILED DESCRIPTION

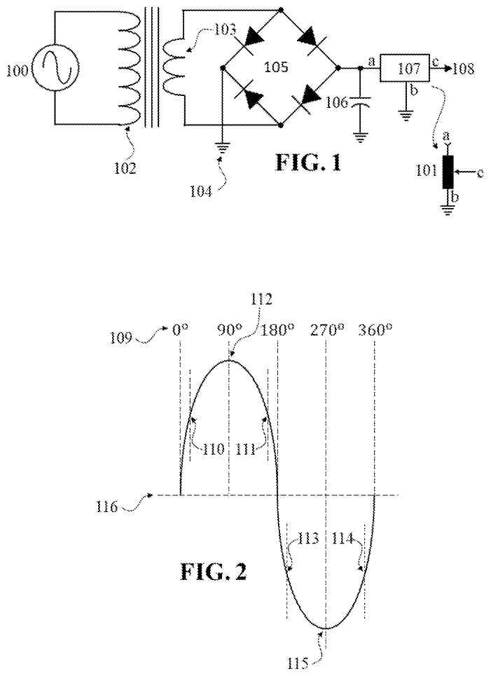

FIG. 2 illustrates the typical AC waveform as is delivered by a power utility company to all homes and offices (AC mains voltage). As visualized on an oscilloscope, the AC voltage waveform cycle represented by FIG. 2 varies from zero volts 116 to a positive peak voltage 112 back to zero volts, then to a negative peak voltage 115, returning to zero volts. It does this infinitely in a sinusoidal pattern consistent with the trigonometric sine function x(t)=Amax*sin θ. In between zero and peak voltage is a full range of instantaneous voltages (Vᵢ) such as indicated by 110, 111, 113 and 114. A full AC cycle can be thought of in terms of angle or phase 109 and divided into 360 degrees or 2π radians. 0° phase to 180° (0 to π radians) phase represents the positive portion of the waveform. Likewise, 180° phase to 360° (π to 2π radians) phase represents the negative portion of the waveform.

For our purposes here, the full cycle can be divided into quarters, the first two quarters would be from 0° phase to 90° (0 to π/2 radians) phase and 90° phase to 180° (π/2 to π radians) phase and together represent the positive half of the waveform. From the illustration, the first quarter rises from 0 volts 116 to peak voltage 112 while the second quarter falls from peak voltage 112 to 0 volts 116. The peak of the waveform is at 90° (π/2 radians). Whatever happens during the first quarter cycle from 0 volts 116 to peak voltage 112 is mirrored in the second quarter cycle from peak voltage 112 to zero volts 116. The instantons voltages for the first quarter cycle are repeated in reverse in the second quarter cycle. For example, instantaneous voltage 110 is the same for 111 if each (110 and 111) are phase equidistant from 90° 112 (π/2 radians). This same scenario plays out in the third and fourth quarter cycle where 113 and 114 are the same negative voltage if they are phase equidistant from 270° 115.

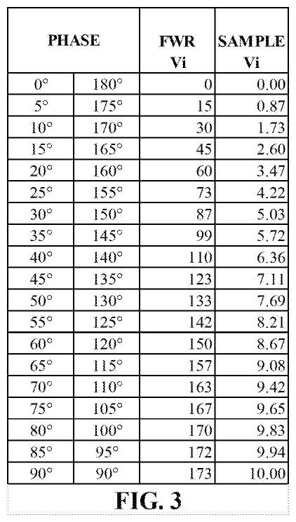

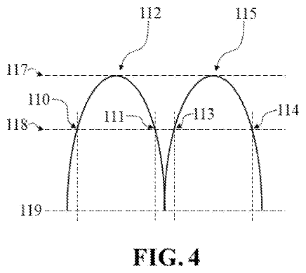

FIG. 3 is divided into 3 columns as follows:
1. PHASE—Further divided into phases for the rising quarter cycle and phases for the descending quarter cycle. In terms of Vᵢ, these phases correlate.
2. FWR Vᵢ—The Vᵢ present on the positive pin of the FIG. 1 FWR assuming standard USA mains voltage is driving the FWR.
3. SAMPLE Vᵢ—A 1:16 sample of the FWR voltage will be used in a later discussion. The figures in this column represent the Vᵢ values for the 1:16 sample for various phases.

FIG. 3 represents the instantaneous voltages (Vᵢ) present in AC mains at specific phases during the first half of the AC wave (positive portion). Vᵢ figures in FIG. 3 are consistent with typical 120VAC RMS USA mains voltages. The instantaneous voltages listed in FIG. 3 occur twice in each half cycle (e.g., 133v at 50° and 130° phase). For our purposes, we can denote phases that are equidistant from the peak phase 90° or 270° as “corresponding phases”. All Vᵢ voltages in FIG. 3 are approximate.

If a circuit were constructed such that a brief connection was made from the AC mains directly to a load at a pair of corresponding phases, the load would experience two pulses at a specific voltage. For example, if we made such a connection at 5° phase and the corresponding 175° phase, the load would receive two 15v pulses.

The premise of the invention presented here is that connecting the AC mains voltage directly to the load at specific phases when the mains instantaneous voltage is within a desired range of instantaneous voltages, one can regulate the desired voltage present at the load. To make this connection from mains to load at the proper phases, a low-voltage sample of the AC waveform is extracted from the AC mains via a voltage divider. The AC mains sample is then compared with high and low set-point voltages. When the AC mains sample voltage is greater than the low set-point voltage, but less than the high set-point voltage, AC mains voltage is connected directly to the load.

FIG. 4 illustrates a full wave (0° phase through 360° phase) that results from full-wave rectification. Included are peak voltages 112 and 115 that intersect the 117 “peak voltage” line and instantaneous voltages (Vᵢ) 110, 111, 113 and 114 that intersect the Vᵢ line 118. For our purposes here, assume the phases of each of these instantaneous voltages correspond to the Vᵢ line 118 of 100v and the cycle repetition is 60 per second. If the AC input were briefly connected directly to a load each time Vᵢ=100v, the load would receive 240 pulses per second at 100 volts each.

There is much that can be done with such a pulse stream of this type and with some creativity, we can vary the low and high set-points to control output voltage and current flow. We can dynamically raise or lower the set-points to control behaviors in the load such as motor speed, capacitor charging speed and LED brightness.

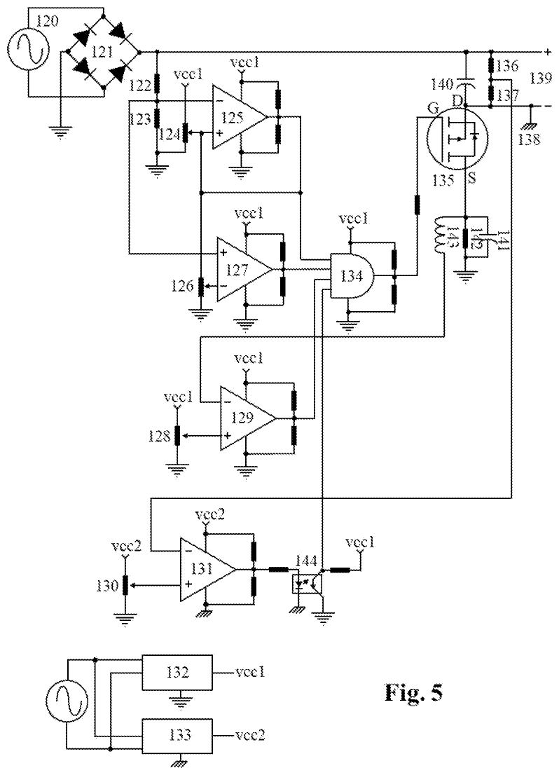

FIG. 5 illustrates a phase-regulated AC to DC power supply. This design is dependent on a pair of low-output DC “logic” power supplies 132 and 133 like the type detailed earlier in FIG. 1. For the purposes of explanation, assume that both logic supplies produce 12VDC and can handle a load of 1 watt. Note the different ground (“DC Common”) symbols. Logic supply 132 will be used for logic upstream of the FET 135. Logic supply 133 will be used downstream of the FET 135.

As with the basic power supply detailed in the FIG. 1 discussion, the phase regulated power supply receives input from AC mains 120 that is converted to alternating DC (diagramed in FIG. 4) by the Full Wave Rectifier (FWR) 121. The negative pin of the FWR is used to establish “DC common” (“DC ground”).

A voltage divider comprised of resistors 122 and 123 extract a sample of the FWR output and sends this to comparators 125 and 127. It is important that the peak instantaneous voltage (Vᵢ) of the sample not, exceed the vcc1 voltage and so for this example, a 1:16 ratio is used for these resistors. Also, 1 mA at peak voltage is more than enough for the comparators. 160 kΩ is recommended for resistor 122 and 10 kΩ is recommended for resistor 123. The max current (Vᵢ at peak voltage) will be 173v/170 kΩ≈1 mA. The voltage drop across resistor 123 is then 1 mA*10 kΩ=10 v. The Vᵢ signal presented to comparators 125 and 127 will vary from 0 v (at phase 0° and 180°) to 10v (at phase 90° and 270°) as the FWR+output varies from 0 v (at phase 0° and 180°) to 173 v (at phase 90° and 270°). Referring once again to the table in FIG. 3, one can estimate the Vᵢ expected on the sample circuit at various phases. For example, at phases 15° and 165°, the FWR Vᵢ will be 45 v and the sample Vᵢ will be 2.60 v. We now have the means for extrapolating an FWR output voltage from a low voltage sample.

Comparator 125 compares the sample signal to a high set-point controlled by variable resistor 124. Comparator 125 outputs a logic “1” when the sample signal Vᵢ is less than the high set-point voltage. Comparator 125 outputs a logic “0” all other times.

Comparator 127 compares the sample signal to a low set-point voltage controlled by variable resistor 126. Because resistor 126 varies from 0 v to the high set-point voltage controlled by variable resistor 124. it acts as a span control (variance between high and low set-points) and variable resistor 124 moves both the low and high set-points. When the sample signal Vᵢ is greater than the low set-point voltage. comparator 127 outputs a logic “1” and a logic “0” all other times.

The AND Gate 134 receives inputs from comparators 125 and 127. This AND Gate has 4 inputs and assuming the other 2 AND inputs are a logic “1” (these will be discussed later), AND Gate 134 outputs a logic “1” when the sample Vᵢ is between the low and high set-points. The AND Gate 134 drives the FET 135 Gate causing the FET to connect DC common ground to one side of the load (capacitor 140 in this example). The other side of the load is the FWR voltage that varies from 0v to 173v. Because of the FET providing a ground connection to the load capacitor 140 only when the FWR Vᵢ is between low and high values correlating to the sample set-points, the capacitor will charge to a voltage correlating to the high set-point voltage. For example, if the high set-point voltage from the sample is 0.87 volts, we can see from the table in FIG. 3 that the capacitor 140 will charge to 15VDC. If we raised the high set-point voltage to 1.73v, we would expect capacitor 140 to charge to 30VDC.

Comparator 129 limits current through the load by comparing the voltage drop across resistor 142 to a current set-point controlled by variable resistor 128. Resistor 142 is in series with the load when the FET is gated. Sampling a voltage drop across this resistor, since its resistance is known, derives current through it and therefore through the load (I=E/R). To avoid waste, the resistance of 142 should be sized as small as is practical for the comparator to sense when a current upper limit is exceeded. For low voltage outputs from the power supply, this value might be 1/2Ω. For larger voltage outputs, this value might be 1/10Ω. Comparator 129 outputs logic “1” when the voltage drop across resistor 142 is less than the current set-point voltage set by resistor 128. When the current through resistor 142 exceeds a current limit established for the load, comparator 129 effectively “extinguishes” the FET 135 connection to the load. Once extinguished, the current, through resistor 142 and therefore the voltage drop across it goes to 0, allowing comparator 129 to once again output a logic “1” needed by the AND Gate to “restart”. Capacitor 141 and inductor 143 delay the restart.

Comparator 131 regulates voltage. A voltage divider 136 and 137 that matches the values of voltage divider 122 and 123 is placed across the load. The voltage drop across resistor 137 is compared to the voltage set-point voltage controlled by resistor 130. When the 137 voltage is less than the 130 voltage, comparator 131 outputs a logic “1” and outputs a logic “0” all other times. In other words, the FET 135 is extinguished when the capacitor 140 is charged to the desired value. When this capacitor is below the desired voltage (demand), the FET reconnects as required to maintain the desired voltage level.

A new “DC Common”/“DC ground” is designated for the load and receives a different “DC ground” symbol 138. Also, comparator 131 has its own logic power supply because of this different “DC ground”. An opto-isolator 144 is required for comparator 131 to communicate with the AND Gate 134.

Loads can be in several forms: capacitive, resistive, inductive, etc. The circuit presented can be a negative supply by designating the FWR output as “DC Common” for the load. The circuit can drive loads such as an LED array directly rather than through a capacitor. In the case of loads such as a motor or LED array, the high set point control 124 can be used as a “course” speed control or brightness control. The low set-point control 126 can also be used as a “fine” control since it determines the span between high and low set-points and therefore duty cycle.

In the foregoing example, our objectives were met as follows:
1. The transformer was eliminated.
2. Voltage and current were regulated without wasting energy.
3. The design is scalable and can be adapted for any AC input or DC output voltage and any output power requirement.
4. The design is simple and compact requiring only a handful of components that could potentially be placed into an integrated circuit.
5. The design is constructed from a handful of inexpensive components and so the aggregate circuit will be inexpensive.

1. A system and methods for extracting electrical energy from an alternating current (AC) power source during a range of AC phases to produce a reduced and regulated voltage output, comprising:
a voltage divider that extracts a low voltage sample of the power source used in concert with voltage comparators and variable resistors to control low and high set-points;
a switching transistor such as a Field Effect Transistor;
one or more low voltage, low output logic power supplies;
digital logic components;
and an opto-isolator.

2. The system and methods of claim 1,
wherein the voltage across a load is regulated by briefly extinguishing the output transistor driving the load when the desired output voltage is achieved comprising;
a voltage divider across a load that extracts a low voltage sample of the power source;
a voltage comparator;
a variable resistor to control the desired voltage output;
an opto-isolator;
and digital logic.

3. The system and methods of claim 1,
wherein, the current through a load is regulated by briefly extinguishing the output transistor driving the load when the desired output current is exceeded comprising;
a low value resistor in series with the load;
a voltage comparator;
a variable resistor to control the cutoff current value;
and digital logic.
